(19) United States
(12) Patent Application Publication
(10) Pub. No.: US 2011/0193293 A1
(43) Pub. Date: Aug. 11, 2011

(54) SEAL ARRANGEMENT

(75) Inventors: Dimitri D.V. MEGA, Derby (GB); Jeffrey A. DIXON, Derby (GB); Colin YOUNG, Derby (GB); Ivan L. BRUNTON, Derby (GB)

(73) Assignee: ROLLS-ROYCE PLC, LONDON (GB)

(21) Appl. No.: 13/021,282

(22) Filed: Feb. 4, 2011

(30) Foreign Application Priority Data
Feb. 10, 2010 (GB) 1002214.3

(51) Int. Cl. F16J 15/447

(52) U.S. Cl. 277/412

(57) ABSTRACT

A seal arrangement provided between a static component and a rotating component arranged for rotation about a rotational axis. The arrangement preferably takes the form of an interstage seal for a gas turbine engine, including: first and second seal members carried by respective said components and arranged concentrically about said rotational axis. The first seal member has a plurality of radially directed seal fins extending towards the second member and a substantially radially directed flow outlet configured to direct a flow of cooling air through the first member. In one aspect of the invention, the second member has a radial projection at one end of its axial length, the projection extending towards the first member at a position spaced axially between the flow outlet and said seal fins. In another aspect of the invention, the flow outlet is axially adjacent a seal fin which is configured so as to be generally concave towards the flow outlet.

The present invention relates to a seal arrangement. More particularly, the invention relates to a seal arrangement provided between a static component and a rotating component, and accordingly is suitable for use as an interstage seal in a gas turbine engine.

A modern gas turbine engine typically incorporates a sophisticated internal air system which, whilst not contributing directly to the thrust generated by the engine, nevertheless has several important functions which contribute to the safe and efficient operation of the engine. Principal among these functions is the cooling of static and rotating components of the engine, including nozzle guide vanes, turbine blades, turbine rotor discs etc; control of turbine blade tip clearances and prevention of hot gas ingestion into, for example, turbine disc cavities. Typically, up to approximately one fifth of the total core mass flow of a modern gas turbine engine may be diverted into the engine's internal air system through bleed outlets at a number of locations within the engine's compressor system. Consequently, significant energy is consumed in compressing the air flowing through the internal air system of the engine. Leakage losses from the internal air system, or less than optimum use of the air for cooling purposes, therefore represent a total energy loss from the engine and thus have a negative effect on engine efficiency.

The provision of effective seals between the static and rotating components of adjacent turbine stages is therefore an important aspect of gas turbine design, because ineffective seals represent escape paths for the cooling air within the internal air system of the engine which results in a loss of compressed air and thus adversely affects the efficiency of the engine. In multi-stage turbines having shrouded nozzle guide vanes at the hub, it is commonplace to provide a labyrinth interstage seal within a so-called “stator well”, the seal being arranged between the rotating hub of the turbine and the radially adjacent stator arrangement. Cooling air is introduced into the stator well through metered holes provided through the hub, upstream of the seal. The interstage seal thus helps define a plenum chamber bounded on an upstream side by a face of a turbine disc, and into which the cooling air is directed in a generally radial manner from within the turbine rotor. However, it has been found that conventional seal arrangements of this general type do not sufficiently optimise the flow of cooling air in the region of the stator well upstream of the seal in order to provide a maximum cooling effect on the outer rim of the upstream rotor disc. It is therefore deemed advantageous to improve the cooling flow behaviour within the stator wells in order to reduce the mass flow rate of cooling air required, and hence reduce the amount of cooling air which needs to be bled from the compressor(s) of the engine, thereby increasing the efficiency of the engine and reducing specific fuel consumption and emissions for a given thrust requirement.

It is therefore an object of the present invention to provide an improved seal arrangement.

According to a first aspect of the present invention, there is provided a seal arrangement between a static component and a rotating component arranged for rotation about a rotational axis, the arrangement comprising: first and second seal members carried by respective said components and arranged concentrically about said rotational axis, said first seal member having a plurality of radially directed seal fins extending towards said second member and a substantially radially directed flow outlet configured to direct a flow of cooling air through the first member, the flow outlet being axially spaced from the fin seals, the seal arrangement being characterised in that said second member has a radial projection at one end of its axial length, the projection extending towards the first member at a position spaced axially between the flow outlet and said seal fins.

Preferably, at least the seal fin axially closest to the flow outlet is generally concave towards the flow outlet.

According to a second aspect of the present invention, there is provided a seal arrangement between a static component and a rotating component arranged for rotation about a rotational axis, the arrangement comprising: first and second seal members carried by respective said components and arranged concentrically about said rotational axis, said first seal member having a plurality of radially directed seal fins extending towards said second member and a substantially radially directed flow outlet configured to direct a flow of cooling air through the first member, the flow outlet being axially adjacent a seal fin which is configured so as to be generally concave towards the flow outlet.

Preferably, the flow outlet is axially spaced from the fin seals, and at least the seal fin axially closest to the flow outlet is generally concave towards the flow outlet.

Advantageously, the arrangement comprises a further substantially radially directed flow outlet configured to direct a secondary flow of cooling air through the first member, the further flow outlet being axially spaced between a pair of said fin seals and being oriented so as to direct said secondary flow for direct impingement against one of said pair of fin seals, said fin seal being generally concave towards the further flow outlet.

Preferably, the flow outlet is axially spaced from the fin seals, and said second member has a radial projection at one end of its axial length, the projection extending towards the first member at a position spaced axially between the flow outlet and said seal fins.

Said radial projection may comprise an integral lip formed at the end of the second member.

Alternatively, or additionally, said radial projection comprises a separately formed ring carried by the second member in the region of said end. Said ring is preferably configured so as to have a lower coefficient of thermal expansion than the rest of the second member.

Preferably, said first seal member is associated with said rotating component, and said second seal member is associated with said static component. In such an arrangement, the rotating component is preferably arranged for rotation within said static component.

The seal arrangement of either the first aspect or the second aspect may be provided in the form of an interstage seal for a gas turbine engine, wherein said first member forms part of the turbine rotor between a neighbouring pair of rotor discs, and said second member forms part of, or is secured to, a nozzle guide vane assembly.

Accordingly, a third aspect of the invention provides a gas turbine engine having a seal arrangement in accordance with either the first or second aspects, in the form of an interstage seal.

So that the invention may be more readily understood, and so that further features thereof may be appreciated, embodiments of the invention will now be described by way of example with reference to the accompanying drawings in which:

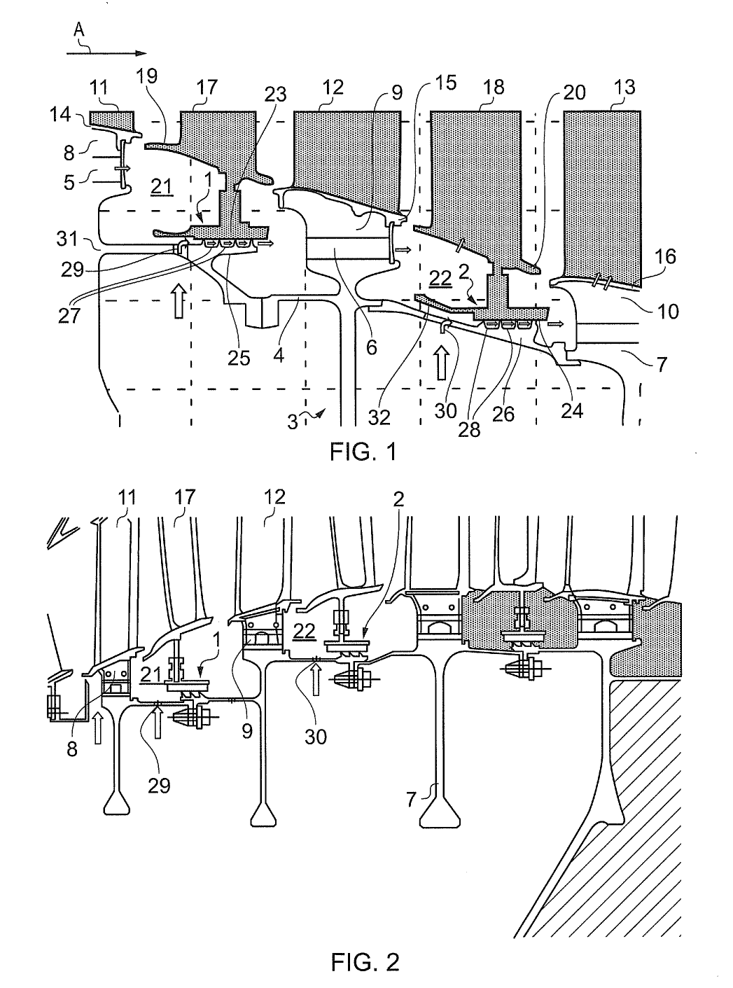

FIG. 1 is a schematic cross-sectional illustration showing a pair of prior art turbine interstage seals in a gas turbine engine;

FIG. 2 is a schematic cross-sectional illustration showing an alternative form of interstage seal in accordance with the prior art;

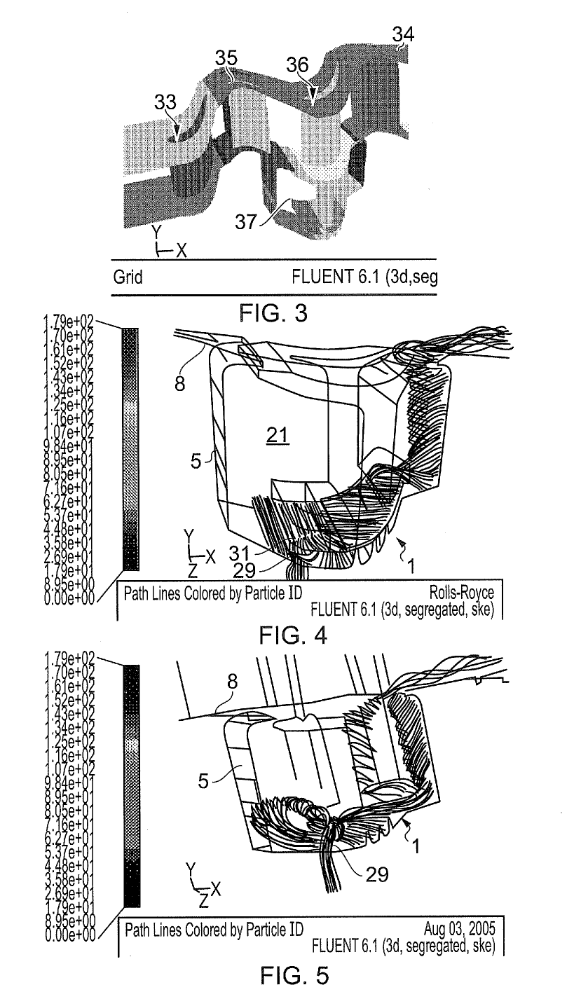

FIG. 3 is a schematic illustration showing a CFD model geometry as used to develop the seal configurations of the present invention;

FIG. 4 is a schematic illustration showing CFD flow visualisations for an interstage seal having the configuration illustrated in FIG. 1;

FIG. 5 is a schematic illustration showing CFD flow visualisations for an interstage seal having the configuration illustrated in FIG. 2:

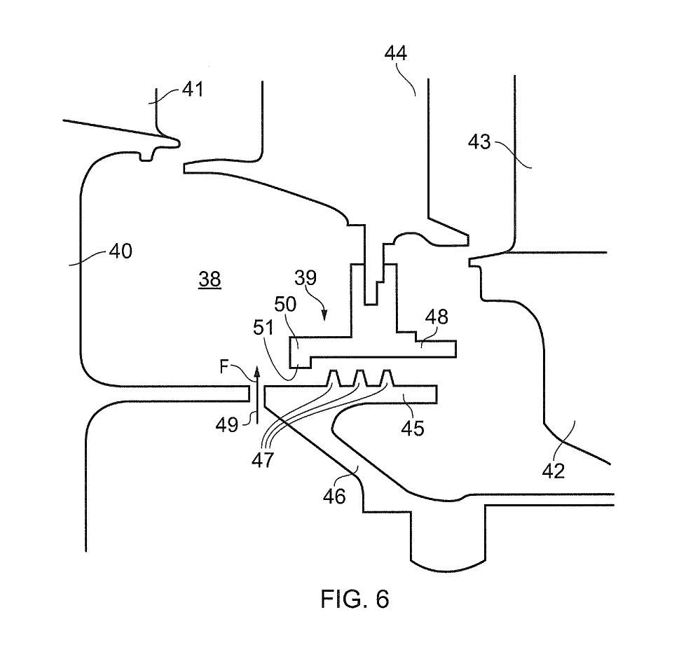

FIG. 6 is a schematic radial cross-section showing a seal arrangement in accordance with a first embodiment of the present invention;

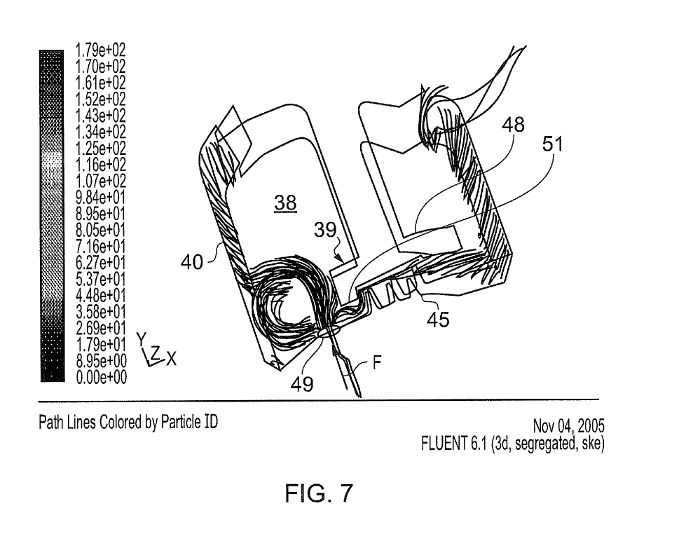

FIG. 7 is a schematic illustration showing CFD flow visualisations for an improved seal having the configuration shown in FIG. 6;

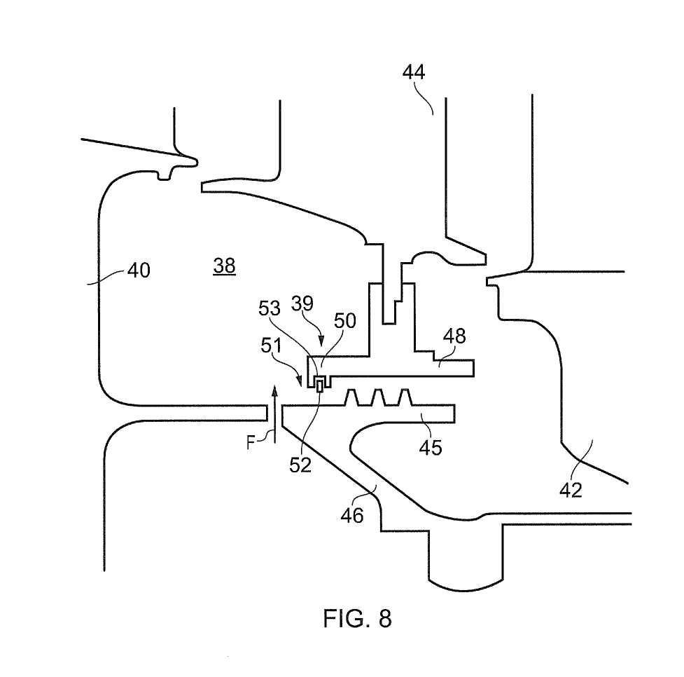

FIG. 8 is a view corresponding generally to that of FIG. 6, but illustrating a modified seal arrangement in accordance with the present invention;

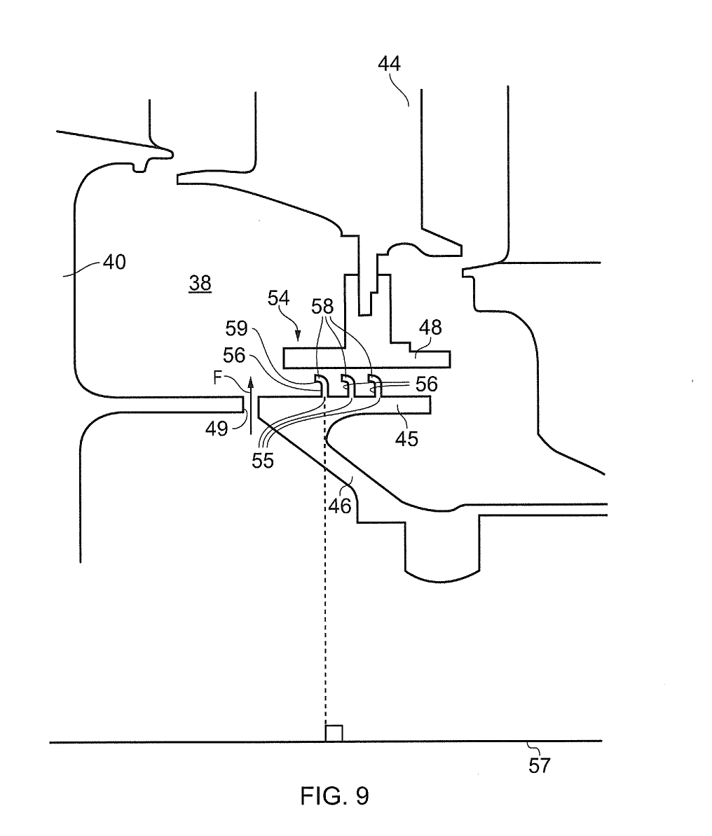

FIG. 9 is a schematic radial cross-section showing a seal arrangement in accordance with another embodiment of the present invention; and

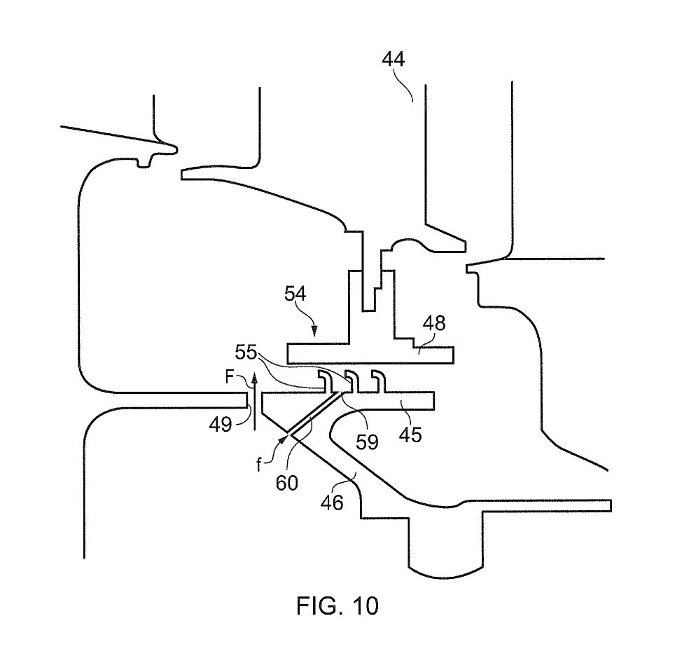

FIG. 10 is a view corresponding generally to that of FIG. 9, but illustrating a modified seal arrangement in accordance with the present invention.

Turning now to consider FIG. 1 in more detail, there is illustrated, in radial cross-section, part of a prior art turbine arrangement including a pair of labyrinth interstage seals 1, 2. As is generally conventional, the turbine rotor 3 is mounted for rotation about the longitudinal axis of the engine and comprises a hub 4 which carries a plurality of axially spaced apart rotor discs 5, 6, 7. Each rotor disc has an outermost rim region 8, 9, 10 to which is mounted a respective array of radially oriented turbine blades 11, 12, 13. The radially innermost end of each turbine blade is provided with a generally circumferentially extending platform 14, 15, 16. The blade platforms 14, 15, 16 of neighbouring turbine blades in each array are arranged so as to substantially abut one another and thus define an annulus representing the inner boundary to the main axial flow of hot gas through the engine, as indicated by arrow A in FIG. 1.

A respective array of radially arranged guide vanes 17, 18 is located between each pair of axially adjacent arrays of turbine blades 11, 12, 13. The guide vanes are typically provided in the form of nozzle guide vane components which are mounted to and hence fixed with respect to the outer casing of the turbine. As will be appreciated, FIG. 1 illustrates only the radially inner ends of the guide vanes 17, 18, but it can clearly be seen that each guide vane component is provided with a generally circumferentially extending shroud portion 19, 20. The shroud portions 19, 20 of neighbouring guide vanes 17, 18 in each array generally abut one another and hence define an annulus representing a further part of the inner boundary to the main gas flow A through the engine.

As will thus be appreciated, during operation of the engine, the turbine rotor 3 rotates at high speed about the longitudinal axis of the engine and thus the arrays of turbine blades 11, 12, 13 are caused to rotate at high speed between the arrays of guide vanes 17, 18. The guide vane components remain static.

A respective stator well 21, 22 is defined between axially adjacent rotor discs 5, 6 and 6, 7. In a radial sense, each stator well 21, 22 is bounded by the respective set of shroud portions 19, 20 and the outer region of the rotor hub 4. More particularly, it will be noted that each of the interstage seals 1, 2 is provided within a respective stator well 21, 22, and thus effectively serves to divide the stator well into two regions, namely an upstream region and a downstream region (relative to the direction of the main gas flow A through the engine).

Each interstage seal 1, 2 comprises a static seal member provided in the form of a foot 23, 24 which is fixedly mounted to a respective nozzle guide vane component 17, 18, and a rotating seal member provided in the form of a respective platform 25, 26 formed as an integral part of the rotor hub 4 between axially adjacent rotor discs 5, 6 and 6,7. Each static foot 23, 24 is provided in close sealing relationship to a respective hub platform 25, 26. As will also be noted, each hub platform 25, 26 is provided with a plurality of axially spaced apart seal fins 27, 28, each of which extends in a generally radial direction towards the adjacent static foot 23, 24.

Each stator well 21, 22 is fed with a supply of cooling air drawn from the upstream compressor system of the engine (not shown) and which is directed into the stator well 21, 22 through a series of substantially radially directed flow outlets 29,30 as indicated schematically in FIG. 1.

As will be appreciated by those of skill in the art, the labyrinth interstage seals 1, 2 are intended to prevent excessive leakage of cooling air from the upstream region of the respective stator well 21, 22 and into the downstream region. Excessive leakage of the cooling air in this manner would reduce the cooling effect of the cooling air on the critical upstream rotor disc 5, 6, and in particular the outer region of the disc rim 8, 9.

The particular prior art interstage seals 1, 2 illustrated in FIG. 1 each comprise a static baffle 31, 32 which is arranged so as to extend axially forwardly from the static foot 23, 24 and to overlie the flow outlets 29, 30. Prior arrangements of this type were provided with such baffle arrangements in order to prevent excessive loss of cooling air through the small gaps existing between the platforms 14, 15 of the upstream turbine blades 11, 12 and the immediately adjacent shroud 19, 20 of the guide vane components 17, 18. In this regard, it will be appreciated that in the absence of the baffles 31, 32 the flow of cooling air directed into the upstream region of the stator wells 21, 22 would be directed generally directly towards the aforementioned gaps between the rotor platforms 14, 15 and the stator shrouds 19, 20. However, as illustrated schematically in FIG. 1, it has been found that the baffles 31, 32 also have a negative effect in that they can have a tendency to direct the flow of cooling air rearwardly and thus through the interstage seals 1, 2 before the cooling air has had an opportunity to circulate significantly within the upstream region of the stator well 21, 22. The baffle arrangement can thus reduce the effect of the cooling air in cooling the outer rim regions 8, 9 of the upstream rotor discs 5, 6.

FIG. 2 illustrates an alternative prior art configuration of interstage seals, the arrangement being generally similar in many respects to the arrangement illustrated in FIG. 1. FIG. 2 therefore uses the same reference numerals to identify identical or equivalent components. However, it will be noted that the main difference between the arrangement illustrated in FIG. 2 and the arrangement illustrated in FIG. 1 is that in the FIG. 2 arrangement, the baffles 31, 32 of the interstage seals 1, 2 have been eliminated, the objective here being understood to be a reduction in the overall weight of the system. As will thus be appreciated, in the FIG. 2 arrangement the flow of cooling air directed radially into the stator wells 21, 22 through the flow outlets 29, 30 has less of a tendency to be directed immediately through the interstage seals 1, 2 and instead can be found to cool the outer rim region 8, 9 of the upstream rotor discs 5, 6 more effectively. Nevertheless, it has been found that the cooling effect of this arrangement is still less than optimal due to the occurrence of significant leakage of cooling air through the interstage seals 1, 2.

The present inventors have made use of a novel application of computational fluid dynamics (CFD) analysis in order more fully to understand the cooling flow behaviour of the prior art seal configurations described above and illustrated in FIGS. 1 and 2, and to devise alternative seal configurations of the type described hereinafter in more detail in order fully to exploit the benefits of improved labyrinth seal geometry and thereby minimise the mass flow rate of cooling air required in order to ensure adequate cooling of the outer rim regions of the turbine rotor discs.

By way of example, FIG. 3 illustrates an exemplary CFD model geometry as used to analyse the cooling flow characteristics within a turbine stator well. In particular, it will be seen that the model geometry covers a section of the turbine extending from a point upstream of the turbine's first stage nozzle guide vane arrangement 33 to a position downstream of the turbine's second stage rotor arrangement 34. Accordingly, the analysed region of the turbine includes the first stage turbine 35 and the second stage nozzle guide vane arrangement 36. In particular, the stator well 37 associated with the second stage nozzle guide vane structure is thus subjected to detailed CFD analysis.

FIG. 4 illustrates a resulting CFD flow visualisation representative of a CFD analysis for a stator well 21 having a labyrinth interstage seal 1 of the type illustrated in FIG. 1 and thus incorporating a forwardly extending baffle 31 arranged so as to overlie the flow outlet aperture 29. FIG. 4 thus effectively illustrates cooling flow path lines which represent the flow of cooling air directed into the stator well 21 through the flow outlet 29. It can thus be seen that the cooling flow is generally directed rearwardly, i.e. axially downstream, from the flow outlet 29 so as to pass through the labyrinth seal 1 and into the downstream region of the stator well 21. Very little of the flow of cooling air is thus circulated around the upstream region of the stator well 21 with the result that the cooling air is ineffective in significantly cooling the upstream surface of the rotor disc 5.

Similarly, FIG. 5 shows a CFD flow visualisation for a stator well having a non-baffled interstage seal of the general type described above and illustrated in FIG. 2. From this drawing it can be seen that removal of the baffle 31 is effective to allow increased circulation of the cooling flow within the upstream region of the stator well 21. Nevertheless it will be seen that even in this arrangement, the region of the cooling flow circulating within the upstream region of the stator well 21 is generally localised in the radially innermost region of the stator well and thus is still generally ineffective in adequately cooling the critical outer rim region 8 of the upstream rotor disc 5.

Turning now to consider FIG. 6, there is illustrated a stator well 38 provided with a modified interstage seal 39 in accordance with a first embodiment of the present invention. In a similar manner to the prior art arrangements illustrated in FIGS. 1 and 2, the stator well 38 illustrated in FIG. 6 is provided between an upstream rotor disc 40 which carries an array of rotor blades 41, and a downstream rotor disc 42 which carries a second array of rotor blades 43 in a generally conventional manner. An array of nozzle guide vane components 44 is arranged between the axially spaced-apart sets of turbine blades 41, 43.

The interstage seal 39 comprises a rotating seal member 45 which is provided in the form of a hub platform formed integrally with the hub 46 of the turbine rotor and which serves to interconnect the neighbouring rotor discs 40 and 42. The rotating seal member 45 is provided with a plurality of radially directed seal fins 47 which extend towards a separate fixed seal member 48 which takes the form of a stator foot fixedly mounted to the radially inner end of the nozzle guide vane component 44. In a generally conventional manner, the rotating seal member 45 and the radially adjacent fixed seal member 48 are arranged in close relationship to one another such that the radially outermost tips of the seal fins 47 lie in close sliding relation to the radially innermost surface of the fixed seal member 48.

The rotor hub 46 is provided with a series of cooling air flow outlets 49 which are arranged in a circumferentially spaced array around the hub 46. Each flow outlet 49 (only one of which is illustrated in FIG. 6) is substantially radially directed and accordingly is configured to direct a flow of cooling air through the rotor hub 46 in the direction indicated generally by arrow F in FIG. 6. As will be noted, the flow outlets 49 are located so as to be axially spaced upstream from the seal fins 47.

The seal arrangement 39 illustrated in FIG. 6 can be considered to be similar in certain respects to the prior art seal arrangement illustrated in FIG. 2, in the sense that the seal arrangement 39 of the present invention does not include a static baffle extending forwardly from the fixed seal member 48 so as to overlie the flow outlet apertures 49. Instead, the seal member 48 terminates at an upstream end 50 at a position spaced axially between the flow outlets 49 and the seal fins 47. More particularly, and in notable contrast to the prior art arrangement illustrated in FIG. 2, the upstream end of the fixed seal member 48 is provided with a projection 51 which is directed radially inwardly towards the adjacent rotating seal member 45 carried by the turbine rotor 46. In the particular embodiment illustrated in FIG. 6, the radial projection 51 is provided in the form of an integral lip formed at the upstream end of the fixed seal member 48.

The radial projection 51 defines a constriction in the region of the upstream end of the interstage seal 39, and in combination with the upstream seal fin 47 effectively defines a somewhat tortuous entry into the labyrinth seal defined between the seal fins 47 carried by the rotating seal member 45 and the radially adjacent fixed seal member 48.

FIG. 7 illustrates a CFD flow visualisation representative of a flow of cooling air directed into the stator well 38 provided with the improved seal arrangement 39 described above and illustrated in FIG. 6. As will be seen, the constriction at the leading upstream end of the interstage seal 39, as provided by the radial projection 51, is effective to restrict the flow of cooling air between the seal members 45, 48 of the seal. Accordingly, a larger proportion of the cooling air flow is retained for circulation around the upstream region of the stator well 38. More particularly, it will be seen that a significant proportion of the cooling air flow is now directed in such a manner as to impinge on the surface of the upstream rotor disc 40.

The modified interstage seal 39 is thus effective to provide a significantly improved flow of cooling air within the upstream region of the stator well 38, thereby more effectively cooling the upstream rotor disc 40. This modified seal arrangement therefore allows a relative reduction in mass flow rate of cooling air in order to provide adequate cooling of the upstream rotor disc 40 which thus permits more efficient operation of the gas turbine engine by requiring less air to be bled from the compressor system of the engine in order to provide the internal cooling air flow.

FIG. 8 illustrates a further modified version of the interstage seal arrangement illustrated in FIG. 6. In this arrangement, it will be seen that the radial projection 51 further comprises a separately formed ring 52 which is received as a close sliding fit within a corresponding recess 53 formed in the integral lip at the upstream end 50 of the fixed seal member 48. It is envisaged that the separate ring 52 will be made from material having a lower coefficient thermal expansion than the material from which the fixed seal member 48 and thus the integral lip 51 itself is formed.

As will be appreciated, during operation of the gas turbine engine the turbine components become subjected to extremely high temperatures. Accordingly, the various components of a conventional interstage seal arrangement can experience thermal expansion during operation. However, due to the relatively low coefficient thermal expansion of the seal ring 52, the ring will experience a lower degree of thermal expansion than, for example, the fixed seal member 48 and, most importantly, the adjacent rotating seal member 45. The sliding interface between the seal ring 52 and the recess 53 allows relative movement between the ring 52 and the integral lip 51 as these two parts expand at different rates, whilst the relatively low level of thermal expansion experienced by the ring 52 is effective to further reduce the size of the constriction between the fixed and rotating seal members as the rotating seal member 45 expands to a greater degree. It has therefore been found that the modified seal arrangement illustrated in FIG. 8 can provide even more efficient use of the cooling air flow F by virtue of reducing leakage of the cooling air flow through the seal 39.

Whilst the modified seal arrangement illustrated in FIG. 8 is configured such that the separate seal ring 52 is received within a recess 53 formed in the integral lip 51, in a further modified arrangement it is envisaged that the integral lip 51 may actually be eliminated, with the recess instead being provided in the main body part of the fixed seal member 48. In such an arrangement, it will be appreciated that the radial projection will be effectively defined exclusively by the radially inwardly directed ring 52.

FIG. 9 illustrates an alternative interstage seal configuration 54 in accordance with another embodiment of the present invention. For convenience, this embodiment is illustrated without the radial projections described above and illustrated in connection with the embodiments of FIGS. 6, 7 and 8. However, it is to be appreciated that the arrangement of FIG. 9 could indeed be further modified so as to incorporate radial projections similar to those illustrated in FIGS. 6 and 8. However, the key aspect of the modified seal arrangement illustrated in FIG. 9 relates to the form of the seal fins 55. In this arrangement, each of the seal fins 55, and most notably the upstream seal fin located closest to the flow outlet 49, are configured so as to be generally concave towards the flow outlet 49. In particular, it will be seen that each seal fin 55 has a radially innermost root portion 56 which extends radially outwardly from the rotating seal member 45 so as to be substantially orthogonal to the longitudinal rotational axis 57 of the turbine. At its radially outermost end, each seal fin 55 has a forwardly turned lip 58 which extends generally axially forwardly and which defines a curved surface 59 is which is generally concave towards the flow outlet 49.

Through the use of CFD analysis, similar to the technique described above, it has been found that the modified seal fin configuration described above and illustrated in FIG. 9 is effective to further reduce the leakage of cooling air flow F through the interstage seal 54. In particular, it has been found that the concave configuration of the fin seals 55, and in particular in the case of the upstream fin seal located closest to the flow outlet 49, is effective to reverse the flow of any cooling air trying to leak past the seal in a downstream direction, so that the cooling air is redirected in an upstream direction towards the upstream region of the stator well 38. This deflected flow of cooling air has been found to contribute to a reduction in the effective cross-sectional area of the gap between the seal members 45, 48, rather in the manner of a boundary layer of flow, thereby reducing the leakage of cooling air through the seal 54.

FIG. 10 illustrates a modified form of the arrangement illustrated in FIG. 9 in which a secondary flow outlet 59 is provided between an axially neighbouring pair of the seal fins 55. The secondary flow outlet 59 is provided at the end of a secondary flow duct 60 and is thus arranged so as to direct a secondary flow f of cooling air through the rotor hub 56 and against the immediately downstream (in this case middle) seal fin 55. Because the middle seal fin 55 has a similar concave configuration to that of the upstream seal fin located closest to the primary flow outlet 49, the secondary flow f is also deflected so as to be redirected in an upstream direction, contrary to the flow direction of cooling air trying to leak through the seal arrangement 54. The secondary flow of cooling air f, and in particular the concave configuration of the adjacent seal fin 55, is thus effective to supplement the reversed flow of cooling air arising from the upstream seal fin 55 in order to further improve the reduction in the effective cross-sectional area of the seal, and thereby further limit leakage of cooling air in a downstream direction through the seal.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A seal arrangement provided between a static component and a rotating component arranged for rotation about a rotational axis, the arrangement comprising:
first and second seal members carried by respective said components and arranged concentrically about said rotational axis, said first seal member having a plurality of radially directed seal fins extending towards said second member and a substantially radially directed flow outlet configured to direct a flow of cooling air through the first member, the flow outlet being axially spaced from the fin seals, the seal arrangement being characterised in that said second member has a radial projection at one end of its axial length, the projection extending towards the first member at a position spaced axially between the flow outlet and said seal fins.

2. A seal arrangement according to claim 1, wherein at least the seal fin axially closest to the flow outlet is generally concave towards the flow outlet.

3. A seal arrangement provided between a static component and a rotating component arranged for rotation about a rotational axis, the arrangement comprising:
first and second seal members carried by respective said components and arranged concentrically about said rotational axis, said first seal member having a plurality of radially directed seal fins extending towards said second member and a substantially radially directed flow outlet configured to direct a flow of cooling air through the first member, the flow outlet being axially adjacent a seal fin which is configured so as to be generally concave towards the flow outlet.

4. A seal arrangement according to claim 3, wherein the flow outlet is axially spaced from the fin seals, and at least the seal fin axially closest to the flow outlet is generally concave towards the flow outlet.

5. A seal arrangement according to claim 2, comprising a further substantially radially directed flow outlet configured to direct a secondary flow of cooling air through the first member, the further flow outlet being axially spaced between a pair of said fin seals and being oriented so as to direct said secondary flow for direct impingement against one of said pair of fin seals, said fin seal being generally concave towards the further flow outlet.

6. A seal arrangement according to claim 3, wherein the flow outlet is axially spaced from the fin seals, and said second member has a radial projection at one end of its axial length, the projection extending towards the first member at a position spaced axially between the flow outlet and said seal fins.

7. A seal arrangement according to claim 1, wherein said radial projection comprises an integral lip formed at the end of the second member.

8. A seal arrangement according to claim 1, wherein said radial projection comprises a separately formed ring carried by the second member in the region of said end.

9. A seal arrangement according to claim 8, wherein said ring is configured so as to have a lower coefficient of thermal expansion than the rest of the second member.

10. A seal arrangement according to claim 1, wherein said first seal member is associated with said rotating component, and said second seal member is associated with said static component.

11. A seal arrangement according to claim 9, wherein said rotating component is arranged for rotation within said static component.

12. A seal arrangement according to claim 1, provided in the form of an interstage seal for a gas turbine engine, wherein said first member forms part of the turbine rotor between a neighbouring pair of rotor discs, and said second member forms part of, or is secured to, a nozzle guide vane assembly.

13. A gas turbine engine having at least one seal arrangement according to claim 12.
